(19) United States
(12) Patent Application Publication
(10) Pub. No.: US 2020/0115074 A1
(43) Pub. Date: Apr. 16, 2020

(54) Methods and Apparatus for Automatically Filling Dispensing Containers

(71) Applicant: MEDI-Clear Ltd, Hull (GB)

(72) Inventor: Mark Paul HOGAN, Hull (GB)

(21) Appl. No.: 16/155,996

(22) Filed: Oct. 10, 2018

(51) Int. Cl. B65B 5/10; A61J 7/00

(52) U.S. Cl. CPC B65B 5/103; A61J 7/0084

(57) ABSTRACT

An apparatus is specifically adapted for use with a dispensing container having a tray with one or more discrete cavities for receiving medication, and a seal. The tray includes a machine-readable marker that encodes a unique identifier for the tray and the seal includes a pre-defined area for thermal printing. The apparatus includes a reader adapted to read the marker on the tray and to obtain, from the marker, the unique identifier for the tray. The apparatus also includes a controller adapted to receive patient-specific information and to associate the patient-specific information with the unique identifier for the tray, and a medication dispenser for automatically filling one or more cavities of the tray with medication with reference to the patient-specific information. A sealing unit is adapted to automatically apply the seal to the tray. The thermally printed human-readable information is directly derived from at least some of the patient-specific information.

### CROSS-REFERENCE TO EARLIER APPLICATION

The present application describes an invention, invented by the present inventor, and that is described in Great Britain Patent Application No. 1705602.9, the disclosure of which is expressly incorporated by reference herein in its entirety.

### FIELD OF THE INVENTION

The invention relates to methods and apparatus for automatically filling dispensing containers with medication such as pills, tablets and capsules, and to the dispensing containers for use with such apparatus. The dispensing containers are typically used for organizing and storing mixed medication for subsequent dispensation according to a pre-defined dosage regimen. The principle behind such multi-dosage dispensing containers is that a dosage regimen of mixed medication can be organized in advance for a period of a week or more, and a patient or care-giver can then remove from the container, at pre-defined times over the said period, the one or more pills, tablets and/or capsules to be administered on each occasion according to the dosage regimen.

### BACKGROUND TO THE INVENTION

Dispensing containers for the storage and dispensing of pills, tablets and capsules are known. A typical dispensing container includes a tray into which is formed a plurality of discrete cavities and which is closed by a seal. The contents of each cavity may be removed by pushing each pill, tablet or capsule through a rupturable film or foil covering the cavities, or in the case where the seal has a removable portion per cavity, by removing a removable portion to create an opening in the seal through which the contents of the cavity can be dispensed. The dispensing containers can carry one-unit dose of the same medication in each cavity or can be filled with a mixture of medications. The tray can have a p×q array of cavities corresponding to p pre-defined medication times per day over a q-day period, for example. In some cases, not all of the cavities will be filled with medication.

The cavities of the dispensing container can be filled manually. However, apparatus are now available that can automatically fill the appropriate cavities with the correct medication in accordance with the patient's prescription. In one arrangement, a range of different medication is stored in cartridges or cassettes within the apparatus and can be selectively dispensed into the cavities before the apparatus automatically applies a seal to the tray. The patient's prescription information can be entered into the apparatus manually or electronically—for example, by importing or downloading information contained in an e-prescription where a prescriber (e.g., a doctor or other medical professional) transmits electronically a new or repeat prescription to a dispensing location such as a pharmacy.

### SUMMARY OF THE INVENTION

The present invention provides a dispensing container comprising:

a tray with one or more discrete cavities for receiving medication; and

a seal;

wherein the tray includes a machine-readable marker that encodes a unique identifier for the tray; and

the seal includes a pre-defined area for thermal printing.

Two different types of thermal printing can be used, namely direct thermal printing and thermal transfer printing. An apparatus specifically adapted for use with the dispensing container can include a thermal print head adapted to thermally print human-readable information (i.e., data or information that is in a format that can be naturally read by humans such as text constructed from alphanumeric characters or a suitable visual image such as a photograph, for example) on to the pre-defined area for thermal printing before, during or after the seal has been applied to the tray.

The present invention further provides an automatic filling system comprising:

a dispensing container comprising:

a tray with one or more discrete cavities for receiving medication; and

a seal;

wherein the tray includes a machine-readable marker that encodes a unique identifier for the tray; and

the seal includes a pre-defined area for thermal printing; and

an apparatus specifically adapted for use with the dispensing container, the apparatus comprising a reader, a controller, a medication dispenser, a sealing unit, and a thermal print head;

wherein, when a tray is positioned in the apparatus, the system carries out the following steps:

the reader reads the marker on the tray and obtains, from the marker, the unique identifier for the tray;

the controller receives patient-specific information and associates the patient-specific information with the unique identifier for the tray;

the medication dispenser automatically fills one or more cavities of the tray with medication with reference to the patient-specific information associated with the unique identifier;

the sealing unit automatically applies the seal to the tray; and

the thermal print head thermally prints human-readable information on to the pre-defined area for thermal printing ink before, during or after the seal has been applied to the tray, the human-readable information being directly derived from at least some of the patient-specific information associated with the unique identifier.

The medication dispenser preferably further comprises a plurality of cassettes for storing medication.

In the case of direct thermal printing, a patch of thermoprint ink can be pre-applied to the pre-defined area of the seal using a suitable process, e.g., flexographic printing. It will be readily appreciated that the seals for use with the direct thermal printing process will be supplied with the patch of thermoprint ink already applied so that they are ready for thermal printing by the apparatus. A plurality of seals can be provided as a continuous reel or stacked in a seal feeder unit of the apparatus until they are required. The thermoprint ink is heat-sensitive and will change color, e.g., from light to dark, to give a permanent image when heated by the thermal print head of the apparatus. The thermoprint ink can also change opacity, e.g., from substantially transparent or translucent to opaque when heated. The activation temperature of the thermoprint ink can be selected to be compatible with the thermal print head of the apparatus. The permanent image will be determined by the thermal print head and will result in the human-readable information (e.g., text or image) being thermally printed on the seal. In particular, the thermal print head will normally include a plurality of heating elements, typically arranged as a closely spaced dot matrix. When the thermal print head is in close proximity to the thermoprint ink patch, the individual heating elements can be selectively controlled to apply heat to activate the thermoprint ink in such a way as to thermally print the human-readable information as the permanent image on the seal. The parts of the thermoprint ink patch to which heat is not applied by the thermal print head (i.e., which are not activated) will not change color or opacity.

Suitable thermoprint inks are supplied under the brand name Thermosil by Siltech Limited of Church Street, Lenton, Nottingham, NG7 2FH, United Kingdom.

In the case of thermal transfer printing, a transfer ribbon (or printer foil) is interposed between the thermal print head and the pre-defined area of the seal. The transfer ribbon typically has a wax-based ink on a backing layer. When the thermal print head is in close proximity to the transfer ribbon, the individual heating elements can be selectively controlled, in a similar way to direct thermal printing described above, to melt the ink onto the seal in such a way as to thermally print the human-readable information as a permanent image. When cooled, the ink is permanently adhered to the seal surface. Any wax-based ink which is not melted by the thermal print head remains adhered to the backing layer. Optionally, a patch of ink and/or a suitable primer can be pre-applied to the pre-defined area of the seal using a suitable process. The ink is then melted on to the pre-applied ink patch and/or primer during the thermal transfer printing.

It will be readily appreciated that different heating elements of the thermal print head can be selected to create specific human-readable information (e.g., specific text or image) for each individual seal. In particular, a thermal print head controller can process the patient-specific information associated with the unique identifier, extract the part of the patient-specific information that is to be thermally printed (along with any other information—see below), and control the thermal print head accordingly. The apparatus controller can also extract the part of the patient-specific information that is to be thermally printed and send this to the thermal print head controller. In one arrangement, only the heating elements in the dot matrix that correspond to the specific text or image are controlled to apply heat to the thermoprint ink or the transfer ribbon.

In an alternative arrangement, at least part of the seal can be adapted for direct thermal printing without the need for a thermoprint ink patch. In other words, the seal will change color or opacity to give a permanent image when heated by the above-described thermal print head of the apparatus. The seal can be coated with a thin layer of heat-sensitive material or heat-sensitive material can be integrated or dispersed within the seal itself, i.e., within the seal material such as a plastics material. Although only the pre-defined area of the seal needs to be directly thermally-printable, it will often be the case that the whole of the seal (or, in the case of a multi-layer construction, the whole of the top layer) is directly thermally-printable, which provides flexibility when selecting the location for the printed human-readable information. The seal can comprise a flexible film or sheet of plastics material (e.g., polypropylene) and will typically be substantially transparent or translucent. The thin layer of heat-sensitive material can be coated on all or part of the top surface of the flexible film or sheet, i.e., on the seal surface that is adjacent the thermal print head in use, or the heat-sensitive material can be integrated or dispersed within all or part of the of the seal material (or, in the case of a multi-layered construction, the whole or part of the top layer). The heat-sensitive material will also typically be substantially transparent or translucent before being heat activated. When the thermal print head is in close proximity to the seal, and in particular to the pre-defined area for thermal printing, the individual heating elements can be selectively controlled to apply heat to activate the heat-sensitive material in such a way as to thermally print the human-readable information as the permanent image on the seal.

In one arrangement, the seal comprises a flexible sheet of plastics material that is substantially transparent or translucent, and the seal is directly thermally-printable with human-readable information in at least the pre-defined area for direct thermal printing.

The dispensing container can be a multi-dosage dispensing container.

The tray of the dispensing container can have any suitable number of discrete cavities arranged in any suitable p×q array, e.g., a 2×7, 3×7, 4×7 or 5×7 array of cavities. The tray typically includes a generally planar top surface into which the cavities are formed and to which the seal is adhered after one or more cavities have been automatically filled by the apparatus.

The machine-readable marker can be pre-applied to the tray using any suitable process, e.g., a printing process. It will be readily appreciated that the trays for use with the apparatus will be supplied with the machine-readable marker already applied. The trays can be manually inserted into the apparatus or stacked in a tray feeder unit of the apparatus until they are required.

The marker can be located on a suitable part of the tray, and in particular where it is accessible to the reader when correctly positioned in the apparatus. The marker can be any suitable visual, machine-readable, pattern that encodes a unique identifier for the tray, e.g., a one-dimensional (or linear) barcode or a two-dimensional (or matrix) barcode. The marker will be compatible with the reader of the apparatus. The unique identifier can be a unique data or information string that allows the apparatus to register (and optionally record) the unfilled tray for compliance purposes and to associate or connect the unique data or information string with the patient-specific information received by the apparatus so that the tray can be automatically filled with the appropriate medication for the particular patient.

The seal can have any suitable single- or multi-layer construction and can be rupturable or non-rupturable, i.e., with a removable portion per cavity. In the case of a non-rupturable seal, the seal can include pre-formed lines of separation that define a removable portion per cavity to retain the medication in that cavity until it is removed along its line of separation. Each removable portion can be attached to the remainder of the seal by a frangible bridge region defined by a gap in the associated pre-formed line of separation. Each removable portion can include a lug portion that can be grasped by a user preparatory to removing the removable portion.

The seal is preferably a flexible plastics film or sheet (e.g., polypropylene) of single- or multiple-layer construction. The seal is preferably substantially transparent or translucent so that the contents of the cavities are visible through the seal. But in other arrangements the seal can be opaque and can be a metal foil, such as aluminum foil, or a metallized polymeric film or paper sheet, for example.

The seal is adapted to be adhered to the tray to seal the one or more discrete cavities and the sealing unit of the apparatus can use any suitable sealing process. In particular, the seals can be adhered to the tray using a heat seal or cold seal process and an appropriate heat seal or cold seal adhesive or lacquer can be pre-applied to the bottom surface of the seal (i.e., the surface that is in contact with the tray in use).

The pre-defined area for thermal printing will typically be positioned so that it does not interfere with or obscure any other printing on the seal, e.g., any visual markings or text that indicate when the patient should take the medication in the underlying tray cavity, or any removable portions if the seal is non-rupturable. The pre-defined area should also preferably be in a part of the seal that is readily visible to the patient or pharmacist. In the case of direct thermal printing, the thermoprint ink patch can be pre-applied to any suitable part of the seal, and in particular where it is accessible to the thermal print head for the thermal printing process before, during, or after the seal has been applied to the filled tray. The thermoprint ink patch can have any suitable size, shape and thickness (or coating weight).

The present invention further provides a method for automatically filling a dispensing container comprising a tray with one or more discrete cavities for receiving medication, and a seal, wherein the tray includes a machine-readable marker that encodes a unique identifier for the tray and the seal includes a pre-defined area for thermal printing (i.e., direct thermal printing or thermal transfer printing), the method comprising the steps of:

reading the marker on the tray and obtaining, from the marker, the unique identifier for the tray;

receiving patient-specific information and associating the patient-specific information with the unique identifier for the tray;

automatically filling one or more cavities of the tray with medication with reference to the patient-specific information associated with the unique identifier;

automatically applying the seal to the tray; and

thermally printing human-readable information on to the pre-defined area for thermal printing before, during or after the seal has been applied to the tray, the human-readable information being directly derived from at least some of the patient-specific information associated with the unique identifier.

The patient-specific information can be provided manually or electronically, e.g., from an e-prescription that is transmitted electronically to a remote dispensing location such as a pharmacy where the apparatus is located. Electronic transmission can take place over any wired or wireless network and the apparatus mentioned above can include any appropriate communication unit or use any appropriate communication protocol to receive the patient-specific information.

The patient-specific information can include at least patient identification information and patient prescription information. The patient identification information can be any information or data that can be used to identify the patient and includes inter alia the patient's name, home address, date of birth, NHS number, an image or photograph of the patient, and personal medical details. The patient prescription information can include inter alia details about the prescribed medication (which can be a mixture of medication), dosage instructions, including if any of the medication to be taken by the patient is particularly important, and whether the prescription is a new prescription or a repeat prescription. It will readily be appreciated that these lists are not intended to be exhaustive and that other patient identification information and patient prescription information can be utilized in the present invention as appropriate.

The one or more cavities of the tray are automatically filled with medication (e.g., by the medication dispenser of the apparatus mentioned above) with reference to the patient prescription information. The prescribed medication (which can be a mixture of medication) is dispensed into the appropriate cavities of the tray depending on the dosage instructions. For example, if the tray includes a 4×7 array of cavities corresponding to four pre-defined medication times per day over a seven-day period, and the patient is prescribed a first medication type to be taken first thing every morning and a second medication type to be taken every evening, the seven cavities in the first array of the tray are automatically filled with the required dose of the first medication type and the seven cavities in the fourth array are automatically filled with the required dose of the second medication type. The cavities in the second and third arrays of the tray are left empty.

The human-readable information that is thermally printed on the seal can include at least some of the patient identification information, e.g., the patient's name. Typically, the human-readable information will be sufficient to ensure that the filled dispensing container is given to the correct patient, and sensitive or confidential information about the patient or the patient's prescription will normally be avoided so that the empty dispensing container can be safely disposed of without compromising the patient's privacy.

Additional information, including information that is not patient-specific, can also be thermally printed on the seal. The additional information might be generated within the apparatus or be apparatus- or pharmacist-specific and can include inter alia human-readable information about the pharmacy or the identity of the pharmacist or other healthcare professional operating the apparatus, warning notices, filling date or expiry date, for example. In some arrangements, machine-readable information (i.e., data, metadata or information that is in a format that can be understood by a computer) or a machine-readable marker can also be thermally printed on the pre-defined area of the seal. The machine-readable information can be directly derived from at least some of the patient-specific information associated with the unique identifier or can be not patient-specific. A machine-readable marker thermally printed on the seal can be any suitable visual, machine-readable, pattern that encodes a unique identifier for the seal, e.g., a one-dimensional (or linear) barcode or a two-dimensional (or matrix) barcode. In one arrangement, the pre-applied machine-readable marker on the tray can be replicated on the seal during the filling process. In other words, the unique identifiers for the tray and seal encoded in the respective machine-readable markers can be the same. The machine-readable marker thermally printed on the pre-defined area of the seal can be read by the same or a different reader to check to see if the respective markers on the tray and seal match.

In practice, any combination of human-readable information and machine-readable information (both patient-specific and non-patient-specific) can be thermally printed on the seal by the thermal print head depending on the particular requirements.

Information might also be conventionally printed separately on a card, sheet or label that is adapted to be adhered to, or supplied with, the dispensing container. The conventionally printed information might include at least some of the patient-specific information associated with the unique identifier. It might, in part, replicate the information printed on the seal. The printing unit (e.g., a conventional printer) can be integrated with the apparatus for automatically filling the dispensing container or connected to the apparatus by means of a wired or wireless network so that patient-specific information that is received by the controller can be transmitted to the printing unit. The conventionally printed information can include dosage instructions for explaining to the patient when the medication needs to be dispensed, although this can also be indicated by appropriate visual markings or text on the seal itself. The conventionally printed information can also include an image or photograph of the patient, details about the filled medication, location information (e.g., the patient's bed or room number in a hospital or care-home environment), the patient's address, details about the patient's doctor, pharmacist or career etc.

### BRIEF DESCRIPTION OF THE DRAWINGS

The present invention can be even more fully understood with the reference to the accompanying drawings which are intended to illustrate, not limit, the present invention.

FIG. 1 is a top view of a tray of a dispensing container according to the present invention.

FIG. 2 is a top view of a first seal of a dispensing container according to the present invention before thermal printing.

FIG. 3 is a top view of a second seal of a dispensing container according to the present invention before thermal printing.

FIG. 4 is a cross section view of a filled dispensing container according to the present invention.

FIG. 5 is a schematic view of an apparatus according to the present invention for automatically filling a dispensing container with medication.

FIG. 6 is a top view of the seal of FIG. 3 after thermal printing.

### DETAILED DESCRIPTION OF THE INVENTION

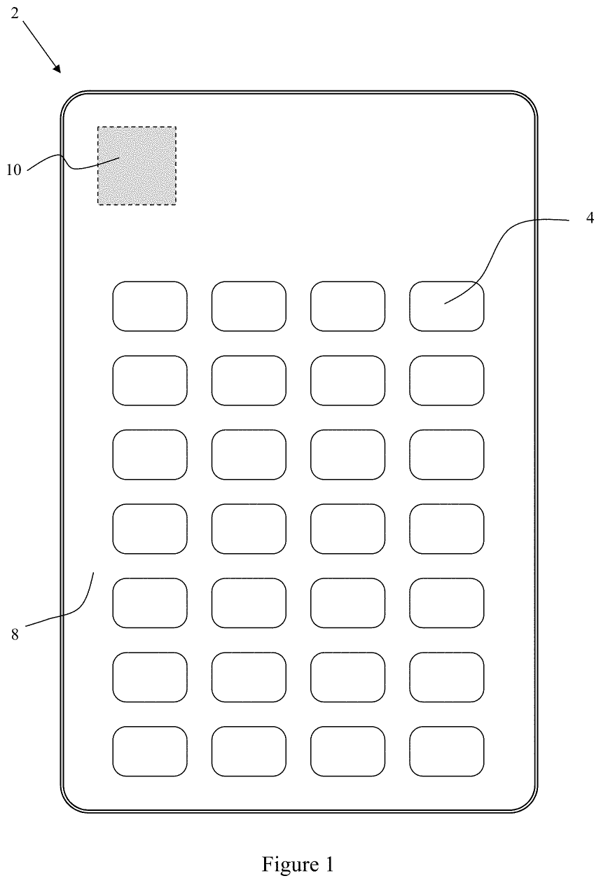

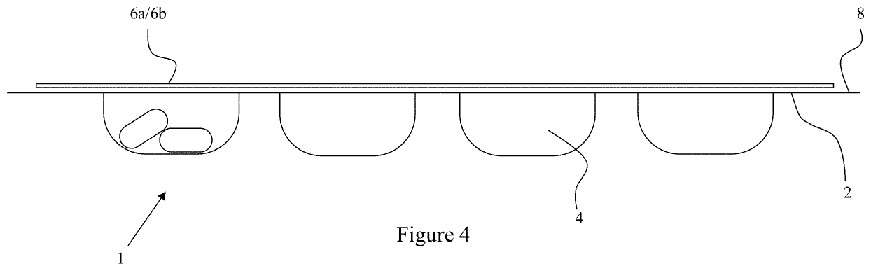

With reference to FIGS. 1 to 4 a dispensing container 1 includes a tray 2 made of a substantially rigid plastics material into which is formed a 4×7 array of discrete cavities 4. The cavities 4 are closed by a seal which is adhered or secured to a generally planar top surface 8 of the tray 2.

The underside of the tray 2 is pre-printed with a machine-readable marker 10 in the form of a two-dimensional (or matrix) barcode. The marker 10 encodes a unique identifier, which can be a unique data or information string.

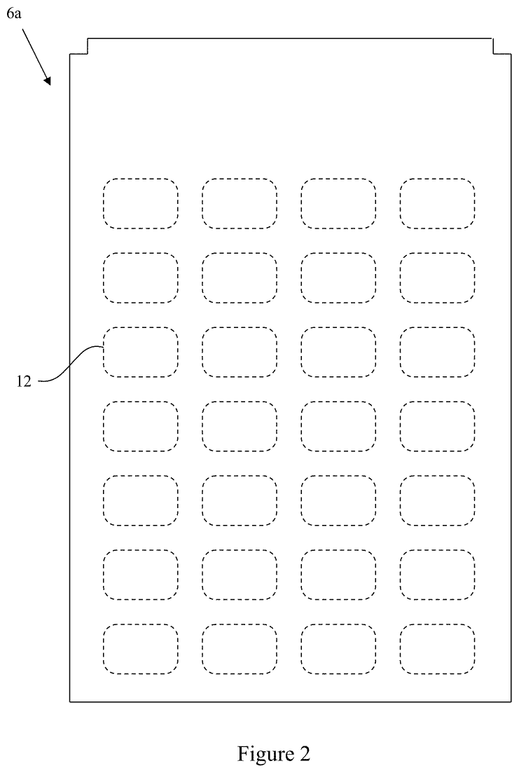

The seal is a flexible sheet of substantially transparent or translucent plastics material (e.g., polypropylene) which is formed with a 4×7 array of removable portions 12 in a known manner. The seal 6a shown in FIG. 2 is specifically adapted for direct thermal printing and heat-sensitive material (not shown) is integrated or dispersed within the plastics material. If the seal 6a has a multi-layer construction, i.e., with a top layer and a bottom layer, the heat-sensitive material need only be integrated or dispersed within one of the layers, typically the top layer.

The heat-sensitive material can be integrated or dispersed within the entirety of the seal (or layer), or only within part of the seal (or layer) that is a pre-defined area for direct thermal printing.

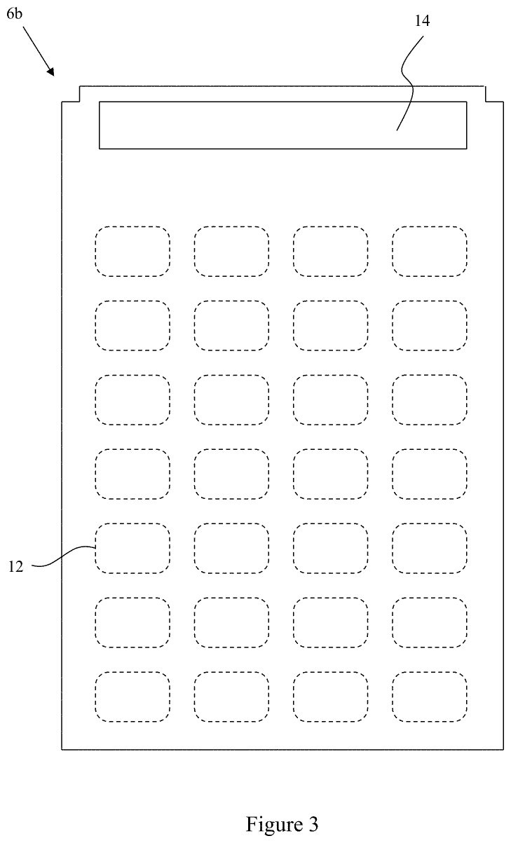

The seal 6b shown in FIG. 3 is also specifically adapted for direct thermal printing and a thermoprint ink patch 14 is pre-applied to the top surface of the seal by flexographic printing.

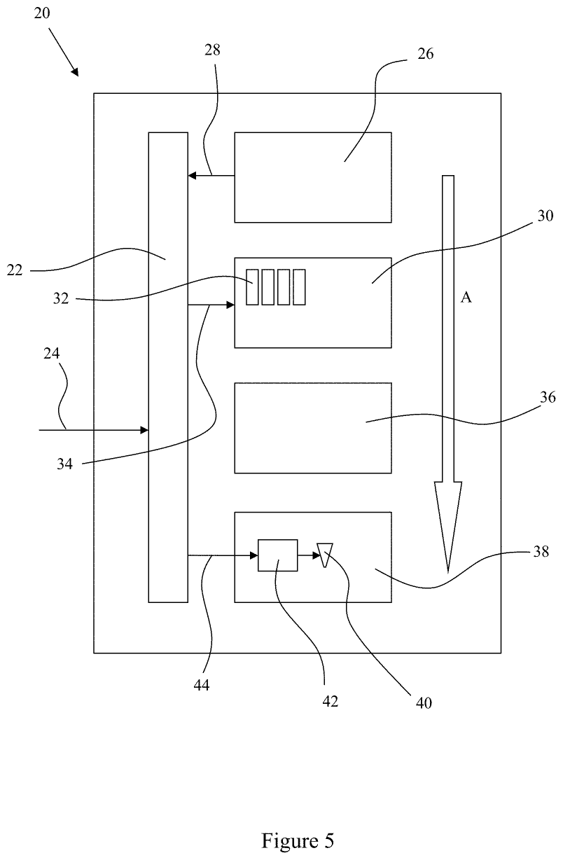

FIG. 5 shows an apparatus 20 for automatically filling a dispensing container with medication.

The apparatus 20 includes a controller 22 which receives electronic patient-specific information 24 in the form of an e-prescription. For the purposes of the present description, the patient-specific information 24 includes the patient's name (so-called “patient identification information”) and the patient's prescription and dosage instructions (so-called “patient prescription information”). In an alternative arrangement, the patient-specific information can be manually entered into the apparatus 20 by the pharmacist on receipt of the patient's paper prescription.

The apparatus 20 includes a barcode reader 26 which is adapted to read the marker 10 on the underside of the tray 2 when the tray is positioned in the apparatus. The barcode reader 26 obtains, from the marker 10, the unique identifier for the tray 2 and sends the unique data or information string 28 to the controller 22. The controller 22 associates or electronically matches the patient-specific information 24 with the unique data or information string 28 obtained from the marker 10.

The apparatus 20 includes a medication dispenser 30 with a plurality of cassettes 32 for storing different medication. The medication dispenser 30 receives patient prescription information 34 from the controller 22.

The apparatus 20 includes a sealing unit 36 (e.g., a conventional heat seal unit) that will automatically apply the seal 6a or 6b to the tray 2 after it has been filled with medication.

The apparatus 20 includes a direct thermal print unit 38 with a thermal print head 40 and a thermal print head controller 42 which receives patent identification information 44 from the controller 22.

The arrow A indicates the processing direction for the apparatus 20. The tray 4 can be moved through a series of separate process stations, e.g., reading, filling, sealing and printing, within the apparatus 20.

When a tray 2 is positioned within the apparatus, its marker 10 is scanned by the barcode reader 26 and the unique data or information string 28 is sent to the controller 22 which associates or electronically matches it with the patient-specific information 24 that it has already received from the e-prescription. In particular, the controller 22 associates both the patient identification information 44 and the patient prescription information 34 with the unique data or information string 28.

The medication dispenser 30 uses the patient prescription information 34 to fill the appropriate cavities 4 of the tray 2 with the relevant medication. The medication can be dispensed from the cassettes 32.

Once the tray 2 has been filled, the sealing unit 36 will automatically adhere the seal 6a or 6b to the generally planar top surface 8 of the tray 2. A plurality of seals can be stored in a seal feeder tray (not shown) that forms part of the sealing unit 36.

The thermal print head 38 is then controlled to thermally print human-readable information 46 on to the seal 6a or 6b after it has been adhered to the tray 2. In an alternative arrangement, the seal can be thermally printed before it is adhered to the tray 2 by the sealing unit 36, or during the sealing process.

In the case of the seal 6a shown in FIG. 2, the human-readable information is directly thermally printed on to the pre-defined area of the seal. In the case of the seal 6b shown in FIG. 3, the human-readable information 46 is directly thermally printed on to the thermoprint ink patch 14 of the seal.

The human-readable information 46 that is thermally printed on the seal can be data or information that is in a format that can be naturally read by humans such as text constructed from alphanumeric characters or a visual image, for example. The human-readable information 46 is derived directly from the patient-specific information 24, and in particular from the patient identification information 44 that is determined by the controller 22. In this specific example, the patient identification information 44 that is sent to the thermal print head controller 42 is the patient's name, namely Joe Bloggs. The thermal print head 40 includes a plurality of heating elements arranged as a closely spaced dot matrix. The thermal print head controller 42 selects specific heating elements to create the text “JOE BLOGGS” for the particular seal to be printed.

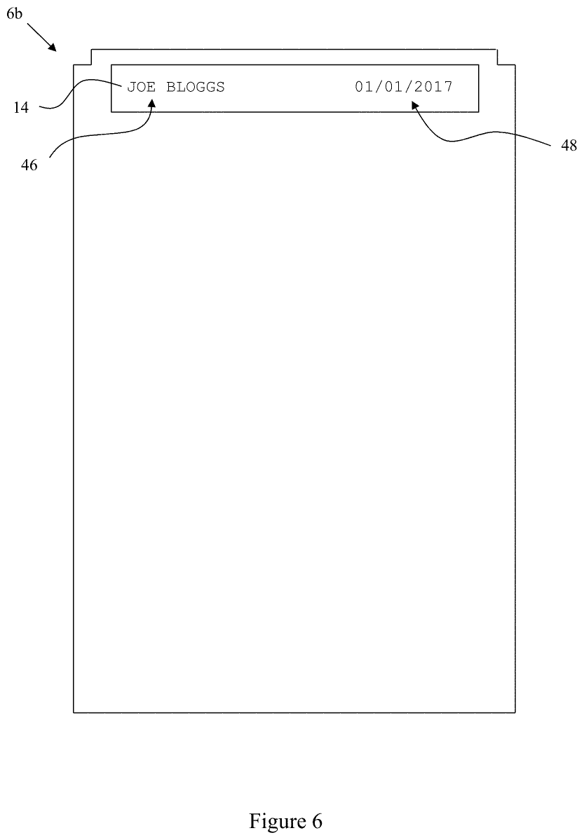

The heating elements apply heat to the seal 6a to activate the heat-sensitive material that is integrated or dispersed within the plastics material of the seal or apply heat to the patch 14 of the seal 6b to activate the thermoprint ink and create a permanent image with the text “JOE BLOGGS”. In the case of the seal 6a shown in FIG. 2, the application of the heat to the seal will change the color or opacity of the actual plastics material to create the permanent image. FIG. 6 shows the seal 6b after it has been thermally printed—it should be noted that the tray has been omitted both for clarity and to emphasize that the seal can be thermally printed before it is adhered to the tray in some arrangements.

The seal 6b shown in FIG. 6 has also been thermally printed with additional human-readable information, namely “Jan. 1, 2017”, that is not patient-specific. This additional human-readable information indicates the date on which the dispensing container was filled by the apparatus 20.

In an alternative arrangement, the apparatus can include a thermal transfer print unit instead of the direct thermal print unit. Such a thermal transfer print unit would still include a thermal print head but would also have means for interposing the transfer ribbon (or printer foil) between the thermal print head and the pre-defined area of the seal for thermal printing.

The present invention can include any combination of these various features or embodiments above and/or below as set-forth in sentences and/or paragraphs. Any combination of disclosed features herein is considered part of the present invention and no limitation is intended with respect to combinable features.

The entire contents of all references cited in this disclosure are incorporated herein in their entireties, by reference. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether such ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof

What is claimed is:

1. A dispensing container comprising:
a tray with one or more discrete cavities for receiving medication; and
a seal;
wherein the tray includes a machine-readable marker that encodes a unique identifier for the tray; and
wherein the seal includes a pre-defined area for thermal printing.

2. The dispensing container of claim 1, wherein the machine-readable marker is a one-dimensional barcode or a two-dimensional barcode.

3. The dispensing container of claim 1, wherein the pre-defined area for thermal printing comprises a patch of thermoprint ink.

4. The dispending container of claim 1, wherein the pre-defined area for thermal printing comprises a patch of ink and/or a primer.

5. The dispensing container of claim 1, wherein the seal is directly thermally-printable in at least the pre-defined area for thermal printing.

6. The dispensing container of claim 5, wherein heat-sensitive material is integrated or dispersed within the seal material.

7. The dispensing container of claim 1, wherein the seal is a flexible plastics film of single- or multiple-layer construction.

8. The dispensing container of claim 1, wherein the seal is substantially transparent or translucent.

9. An automatic filling system comprising:
a dispensing container comprising:
a tray with one or more discrete cavities for receiving medication; and
a seal;
wherein the tray includes a machine-readable marker that encodes a unique identifier for the tray; and
wherein the seal includes a pre-defined area for thermal printing; and
an apparatus specifically adapted for use with the dispensing container, the apparatus comprising a reader, a controller, a medication dispenser, a sealing unit, and a thermal print head;
wherein, when a tray positioned in the apparatus, the system carries out the following steps:
the reader reads the marker on the tray and obtains, from the marker, the unique identifier for the tray;
the controller receives patient-specific information and associates the patient-specific information with the unique identifier for the tray;
the medication dispenser automatically fills one or more cavities of the tray with medication with reference to the patient-specific information associated with the unique identifier;
the sealing unit automatically applies the seal to the tray; and
the thermal print head thermally prints human-readable information on to the pre-defined area for thermal printing before, during or after the seal has been applied to the tray, the human-readable information being directly derived from at least some of the patient-specific information associated with the unique identifier.

10. The system of claim 9, wherein the thermal print head thermally prints machine-readable information on to the pre-defined area for thermal printing before, during or after the seal has been applied to the tray.

11. The system of claim 10, wherein the machine-readable information is directly derived from at least some of the patient-specific information associated with the unique identifier.

12. A method for automatically filling a dispensing container comprising:
a tray with one or more discrete cavities for receiving medication; and
a seal;
wherein the tray includes a machine-readable marker that encodes a unique identifier for the tray; and
wherein the seal includes a pre-defined area for thermal printing;
the method comprising the steps of:
reading the marker on the tray and obtaining, from the marker, the unique identifier for the tray;
receiving patient-specific information and associating the patient-specific information with the unique identifier for the tray;
automatically filling one or more cavities of the tray with medication with reference to the patient-specific information associated with the unique identifier;
automatically applying the seal to the tray; and
thermally printing human-readable information on to the pre-defined area for thermal printing before, during or after the seal has been applied to the tray, the human-readable information being directly derived from at least some of the patient-specific information associated with the unique identifier.

13. The method according of claim 12, wherein the patient-specific information is provided manually or electronically.

14. The method of claim 12, wherein the patient-specific information includes at least patient identification information and patient prescription information.

15. The method of claim 14, wherein the one or more cavities of the tray are automatically filled with medication with reference to the patient prescription information and wherein the human-readable information that is thermally printed on the seal is directly derived from at least some of the patient identification information.
